(19) United States
(12) Patent Application Publication
(10) Pub. No.: US 2020/0361080 A1
(43) Pub. Date: Nov. 19, 2020

(54) ROBOT ARM WITH MODULAR CONSTRUCTION

(71) Applicant: KINOVA INC., Boisbriand (CA)

(72) Inventors: Mathieux BERGERON, Boisbriand (CA); Louis-Pierre FORTIN, Boisbriand (CA); Martin LEROUX, Boisbriand (CA)

(21) Appl. No.: 16/875,454

(22) Filed: May 15, 2020

Related U.S. Application Data
(60) Provisional application No. 62/849,304, filed on May 17, 2019.

(51) Int. Cl. B25J 9/08; B25J 18/00; B25J 17/00

(52) U.S. Cl. CPC B25J 9/08; B25J 17/00; B25J 18/00

(57) ABSTRACT

A motorized joint assembly for a modular robot arm has: a motorized unit having a first shell and a second shell rotatable relative to the first shell about a rotation axis, a motor disposed within and secured to one of the first shell and the second shell, the motor in driving engagement with the other of the first shell and the second shell; a first cap interface mounted on the first shell and a second cap interface mounted on the second shell, the first cap interface defining a first set of connectors for connecting structural members of the modular robot in a first orientation and a second set of connectors for connecting the structural members in a second orientation different than the first orientation.

### CROSS-REFERENCE TO RELATED APPLICATIONS

This application claims priority from U.S. patent application 62/849,304 filed on May 17, 2019. Its content is incorporated herewith in its entirety.

### TECHNICAL FIELD

The present application relates to the field of robotics, such as robot arms that are part of collaborative robots, and more specifically reconfigurable robot arm using modular hardware.

### BACKGROUND OF THE ART

Robotic arms are increasingly used in a number of different applications, from manufacturing, to servicing, and assistive robotics, among numerous possibilities. Traditionally, robotic hardware development is mostly done through simulation in CAD software. While these tools demonstrated their strength, it still remains desirable to build prototype arms to test them in the real world. This latter option is normally more complex as changing actuators or link length is cumbersome.

### SUMMARY

In one aspect, there is provided a motorized joint assembly for a modular robot arm comprising: a motorized unit having a first shell and a second shell rotatable relative to the first shell about a rotation axis, a motor disposed within and secured to one of the first shell and the second shell, the motor in driving engagement with the other of the first shell and the second shell; a first cap interface mounted on the first shell and a second cap interface mounted on the second shell, the first cap interface defining a first set of connectors for connecting structural members of the modular robot in a first orientation and a second set of connectors for connecting the structural members in a second orientation different than the first orientation.

In another aspect, there is provided a modular robot arm comprising: a base securable to a support, the base having a base motorized joint; an effector interface end; and at least one link connecting the effector interface end to the base, the at least one link including a proximal cap interface at a proximal end and connected to the base motorized joint, a distal cap interface at an opposite distal end and connected to a second motorized joint, and struts connecting the proximal cap interface to the distal cap interface, at least one of the proximal cap interface and the distal cap interface defining a first set of connectors and a second set of connectors, the struts selectively connected to the at least one of the proximal cap interface and the distal cap interface along a selective one of a first orientation via the first set of connectors and a second orientation different than the first orientation via the second set of connectors.

Many further features and combinations thereof concerning the present improvements will appear to those skilled in the art following a reading of the instant disclosure.

### DESCRIPTION OF THE DRAWINGS

FIG. 1 is a three-dimensional view of an articulated robot arm with modular construction in accordance with an embodiment;

FIG. 2 is a three-dimensional view of an articulated robot arm with modular construction in accordance with another embodiment;

FIG. 3 is a top view of a pair of interconnected cap interfaces of the robot arms of FIG. 1 and FIG. 2;

FIG. 4 is a three-dimensional view of one of the cap interfaces of FIG. 3;

FIG. 5 is a bottom view of the cap interface of FIG. 4;

FIG. 6 is a side view of the cap interface of FIG. 4;

FIG. 7 is a three-dimensional view of a link of a robot arm in accordance with one embodiment and having a reduction in size in cap interface;

FIG. 8 is a three-dimensional view of a skin for the cap interface of FIG. 4;

FIG. 9 is a three-dimensional view of a strut of the robot arms of FIG. 1 and FIG. 2;

FIG. 10 is a three-dimensional view of a connector tab of the strut of FIG. 9;

FIG. 11 is a schematic cross-sectional view of a motorization unit of the robot arms of FIG. 1 and of FIG. 2;

FIG. 12 is a three-dimensional view of motorization units connected in series as in the robot arms of FIG. 1 and FIG. 2;

FIG. 13 is a three-dimensional view of a base mount in accordance with one embodiment to be used with a robot arm;

FIG. 14 is a block diagram illustrating steps of a method for creating an instruction file for operating a modular robot arm as in FIGS. 1 and 2.

### DETAILED DESCRIPTION

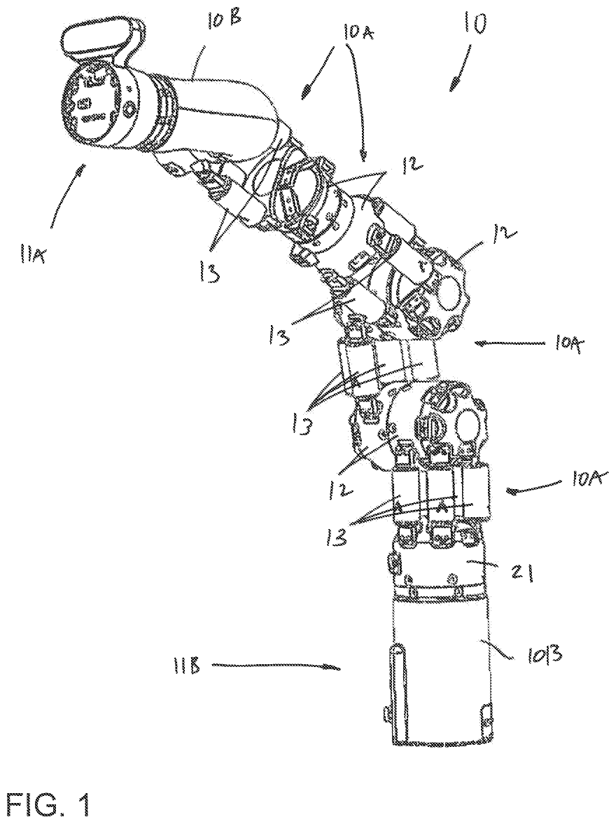

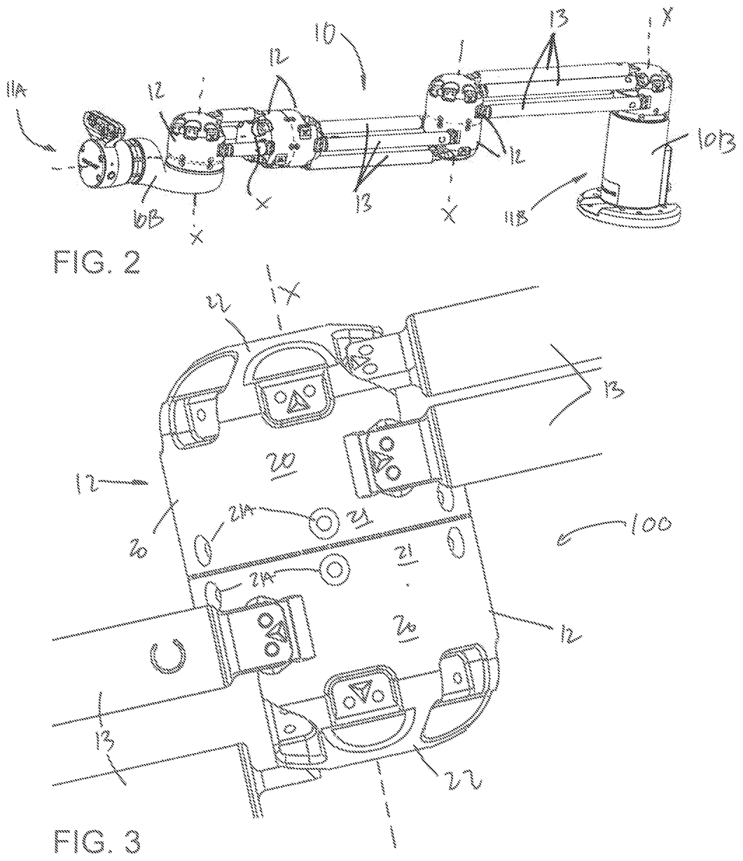

Referring to the drawings and more particularly to FIGS. 1 and 2, a mechanism such as a modular robot arm in accordance with the present disclosure is generally shown at 10. The robot arm 10 may be known as a robot, a robotic arm, an articulated mechanism, a serial mechanism, among other names. The robot arm 10 may be an industrial robot arm, a collaborative robot arm, an assistive robot arm, among other possibilities, with the robot arm 10 being devised for a variety of uses. For simplicity, the expression “robot arm” is used throughout, but in a non-limiting manner. The robot arm 10 is a serial articulated robot arm with a series of links 10A, being modular, or 10B, being hollow shells. One such hollow shell 10B may include a vision system, such as one at the effector end 11A in FIG. 1. In an embodiment, the links at the ends of the robot arm 10 are hollow shells 10B, and the intermediate links are of the 10A type. The modular robot arm 10 has an effector end 11A and a base end 11B, at which hollow shells 10B may be used. For example, in an embodiment, the link 10B at the base end 11B is as described in U.S. patent application Ser. No. 16/570,099, incorporated herein by reference, shown as an example among others. The effector end 11A is configured to receive any appropriate tool, such as gripping mechanism or gripper, an anamorphic hand, three-finger gripper, a suction cup, a magnetic gripper, tooling heads such as drills, saws, a camera, etc. The end effector secured to the effector end 11A is as a function of the contemplated use. The robot arm 10 may be provided without any such tool, and ready for supporting a tool. The base end 11B is configured to be connected to any appropriate structure or mechanism. The base end 11B may be rotatably mounted or not to the structure or mechanism. By way of a non-exhaustive example, the base end 11B may be mounted to a wheelchair, to a vehicle, to a frame, to a cart, to a robot docking station. Although a serial robot arm is shown the joint arrangement of the robot arm 10 may be found in other types of robots, included parallel manipulators.

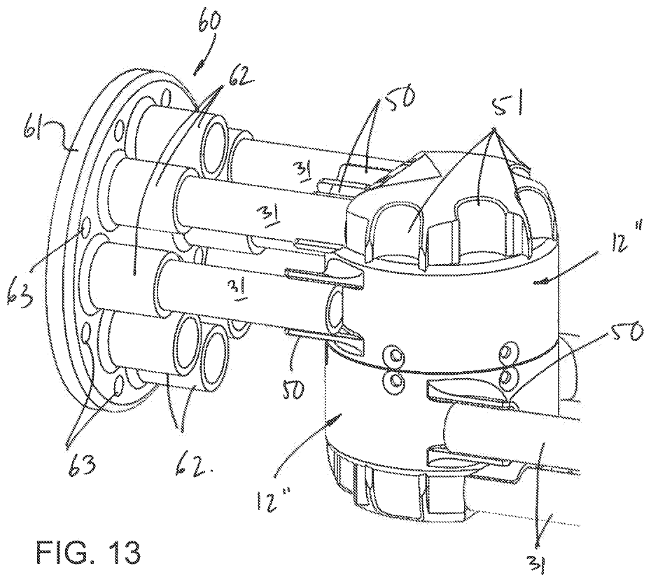

Referring concurrently to FIGS. 1 and 2, a plurality of the links 10A include cap interfaces 12 separated from one another by struts 13. The links 10A are interconnected by motorized joint units 14 (FIGS. 12 and 13, concealed in the cap interfaces 12 in FIGS. 1 and 2.

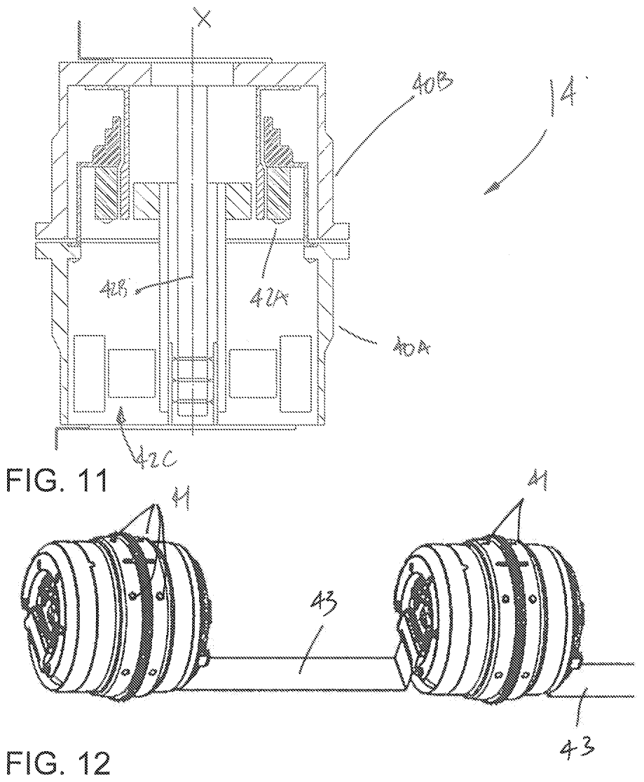

The cap interfaces 12 have a structural function in that they form the skeleton of the robot arm 10, by supporting the motorized joint units 14 (FIG. 11). The cap interfaces 12 may be known as caps, as covers, as interfaces, as receptacles, as connectors, among other possible monikers.

The struts 13 also have a structural function, in maintaining the cap interfaces 12 spaced apart, and by having structural rigidity for the robot arm 10 to have negligible deformation when supporting its own weight and with a tool at the effector end 11A.

The cap interfaces 12 and struts 13 may contribute to the modularity of the robot arm 10. As described below, the cap interfaces 12 are configured to be connected to the struts at different orientations, to form elbow or wrist-style joints. The struts 13 may be of different lengths, for a length of the robot arm 10 to be set based on available space and/or desired working volume and/or intended use, for example.

The motorized joint units 14 interconnect adjacent cap interfaces 12, or a cap interface 12 with a hollow shell 10B, in such a way that a rotational degree of actuation is provided between adjacent cap interfaces 12 and/or shell 10B. According to an embodiment, the motorized joint units 14 may also connect a cap interface 12 to a tool at the effector end 11A, although other mechanisms may be used at the effector end 11A and at the base end 11B. The motorized joint units 14 may also form part of structure of the robot arm 10, as they interconnect adjacent cap interfaces 12.

In the illustrated embodiment of FIG. 1, the robot arm 10 has six motorized joints 14, thus six degrees of freedom (DOFs). In the illustrated embodiment of FIG. 2, the robot arm 10 has five motorized joints 14, thus five DOFs. This illustrates that the robot arm 10 including a modularity set of cap interfaces 12 and struts 13 may have different configurations to provide two or more DOFs.

Referring to FIG. 3, a motorized joint assembly 100 includes a pair of cap interfaces 12 incorporating a motorization unit 14 is shown, showing the struts 13 as well. The motorized unit 14 is described below with reference to FIG. 11. The cap interfaces 12 may rotate relative to one another about axis X. In an embodiment, a vector of the rotational axis X is normal to a plane between the cap interfaces 12. In FIG. 3, an elongated direction of the struts 13 is transverse to the axis X, and this may be referred to as a transverse arrangement. However, as seen in FIGS. 1 and 2, the rotational axis X between adjacent cap interfaces 12 may also be generally parallel to the elongated direction of the struts 13, and this may be referred to as a parallel arrangement. In an embodiment, the cap interfaces 12 are configured to allow both of these orientations. In an embodiment, the cap interfaces 12 are the same.

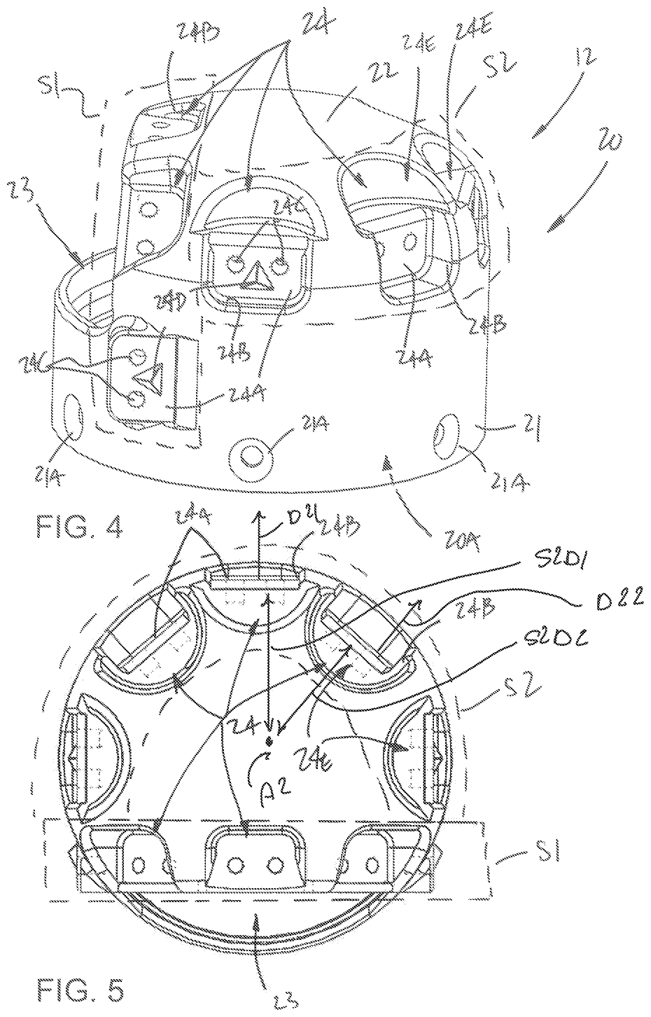

Referring to FIGS. 4-6, an exemplary cap interface 12 is shown in greater detail. According to an embodiment, the cap interfaces 12 may be made from one solid metal piece, i.e., monoblock or monolithic. The cap interfaces 12 may be made of other materials aluminum or like metals if more rigidity is required. In an embodiment, the cap interfaces 12 are made of plastic. The low weight of plastic may enable the use of smaller motorized units 14 by lessening the overall weight of the serial mechanism. If manufactured with an injection molding technique, the cap interfaces 12 may be manufactured at relatively low cost. Other fabrication techniques are applicable like additive manufacturing, machining, etc. could also be used to manufacture the cap interfaces 12. The cap interfaces 12 can also be made of other material like fiberglass reinforced plastic, carbon fiber, polyamide fiber, etc.

For simplicity, exemplary components of the cap interfaces 12 will be given reference numerals in the 20s in the description. The cap interface 12 of FIGS. 4-6 has a receptacle body 20 sized so as to receive therein a shell of a motorization unit 14. Therefore, the receptacle body 20 has an open end 20A by which the motorization unit 14 may be inserted and received in the cap interface 12. A portion of the receptacle body 20 is an annular base 21. The annular base 21 may surround the open end 20A. Holes 21A may be circumferentially distributed around the annular base 21, to match a hole pattern in the motorization units 14. The holes 21A may be for example counterbores and/or countersinks. Although not shown, other components may be present, notably for the angular alignment of the motorization unit 14 in the receptacle body 20, such as a keyway and key arrangement, etc. As another example, posts or equivalent surface features may be circumferentially distributed in the cavity of the receptacle body 20, projecting inwardly (e.g., radially) from a circumferential wall of the cavity of the receptacle body 20, with complementary surface features on the motorization unit 14. The receptacle body 20 may have a closed end, by way of a cap end 22. A window 23 may be defined laterally in the cap end 22, and may serve as a passage for wires interconnected serially the motorization units 14, as shown herein. In an embodiment, there is no cap end 22, with the receptacle body 20 being an open-ended tube at both ends. The cap end 22 may serve to conceal components, such as ports for wiring of the motorization units to one another.

Connector slots 24 are defined in an outer surface of the receptacle body 20. The connector slots 24 are one possible connector configuration that may be present. The connectors 24 may be holes, blocks, tabs, posts, etc. For simplicity, the connector slots 24 are described herein although other types of connectors may be present. The connector slots 24 may be grouped in a first set S1 and a second set S2; the first set S1 being used for the transverse arrangement, while the second set S2 is used for the parallel arrangement. It is also contemplated to use other angled arrangements, as alternatives to the square and parallel arrangements, such as 45 degrees, as an example. In an embodiment, the receptacle body 20 has only one of the first sets S1 and second S2, with cap interfaces 12 being dedicated to either transverse arrangements or parallel arrangements. However, the configuration of the cap interface 12 of FIGS. 4-6 is universal, i.e., transverse arrangements and/or parallel arrangements and/or other angled arrangements being possible, by the presence of the first and second sets S1 and S2. Each of the first and second sets S1 and S2 is shown as having five connector slots 24. There may however be fewer or more connector slot 24 in each set S1 and/or S2, including one or more connector slot 24 by set S1.

The connector slots 24 have a contact surface 24A that may be contoured (e.g., partially peripherally enclosed) by walls 24B, In an embodiment, the contact surface 24A is generally flat, but may be arcuate, slotted, etc. Any suitable shapes are contemplated. Threaded hole(s) 24C are defined through the body 20 and extend from the contact surface 24A. These these threaded holes 24C are threadingly engageable by correspondingly threaded fasteners for securing the struts 13 to the body 20 via the connector slots 24. In the embodiment shown, each of the connector slots 24 includes a pair of the threaded apertures 24C sized to receive fasteners therein, for connection of the struts 13 to the cap interfaces 12. It will be appreciated that other fastening means to secure the struts 13 to the cap interfaces 12 are contemplated, such as, clips instead or in addition to fasteners.

Referring more particularly to FIG. 4, in the embodiment shown, one or more alignment features 24D is present and projects from the contact surface 24A. These features 24D may be omitted in an alternate embodiment. In the embodiment illustrated, the alignment feature 24D is defined by a cavity that tapers away from the contact surface 24A. The alignment feature 24D is herein a triangular-base pyramid. It will be appreciated that other shapes are contemplated. These alignment features 24D may assist in precisely connecting the struts 13 to the cap interfaces 12. Clearances or cutouts 24E are defined by the body 20 and located adjacent to the connector slots 24. These cutouts 24E may ease the attachment of the struts 13 to the cap 12 by limiting interference between the struts 13 and the cap interfaces 12. In an embodiment, the cutouts 24E are sized to be out of an extension of a plane of the contact surface 24A. In an embodiment, central axes of the holes 24C of a same set (e.g., first set S1 and/or second set S2) are oriented to lie in a same plane. Likewise, the alignment features 24D of a same set (e.g., first set S1 and/or second set S2) may intersect a same plane. Such plane of the first set S1 is perpendicular to a rotational plane between adjacent cap interfaces 12, whereas such plane of the second set S2 is parallel to a rotational plane between adjacent cap interfaces 12.

According to an embodiment, all of the cap interfaces 12 of the robot arm 10 are the same, whereby all motorization units 14 can be the same and used interchangeably at any joint between the cap interfaces 12. In such an arrangement, a single type of cap interfaces 12 and of motorization units 14 may be kept in inventory for practical reasons. This may reduce part counts and may reduce costs. In another embodiment, the cap interfaces 12 may be geometrically similar to one another, but with a reduction of size from proximal to distal, with the distal cap interfaces 12 being typically smaller than the proximal cap interfaces 12, as the motorization units 14 being closed to the base end 11B may be required to output more torque to support a greater part of the robot arm 10. Motorization units 14 could come in different sizes in such an arrangement.

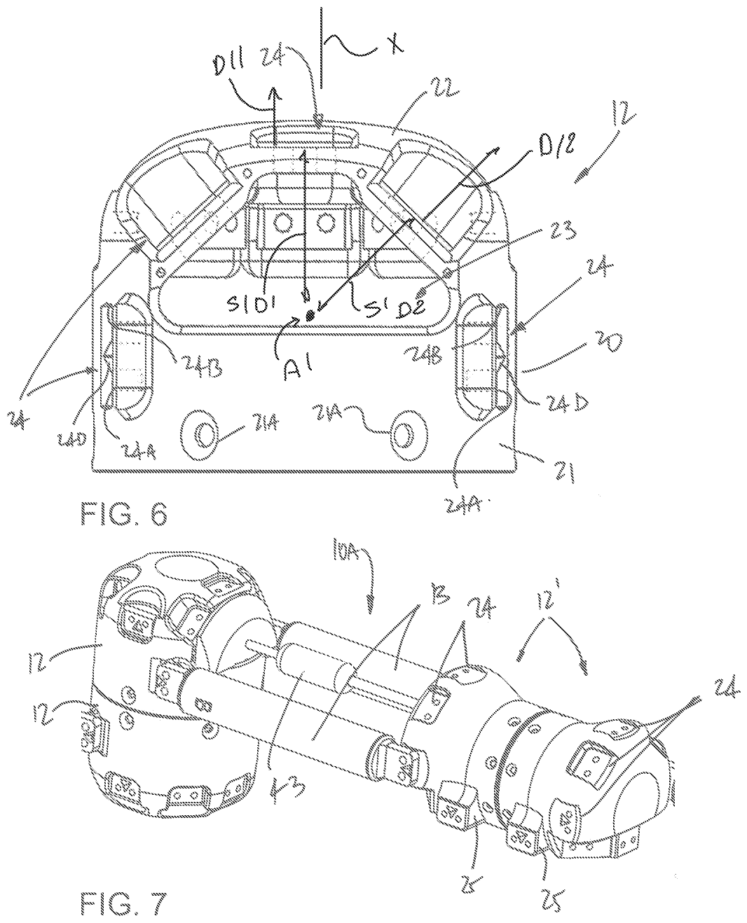

Referring to FIGS. 5-6, a cap interface 12 mountable on the motorized unit 40 (FIG. 11) is shown. The cap interface 12 defines two set of connectors S1, S2 as described above. In the embodiment shown, the first set of connectors S1 is used for connecting structural members (e.g., struts 13) a first orientation and the second set of connectors S2 is used for connecting the structural members 13 in a second orientation angled relative to the first orientation.

Each of the first and second sets of connectors S1, S2 are herein distributed circumferentially around a first axis A1 and a second axis A2, respectively. The first and second axes A1, A2 are non-parallel to one another. Herein, the first and second axes A1, A2 are perpendicular to one another. In the present embodiment, the second axis A2 is parallel to the axis of rotation X. In the embodiment shown, a number of the connectors of the first set of connectors S1 corresponds to a number of the connectors of the second set of connectors S2. To enable that the struts 13 may be selectively connected to either the connectors of the first set S1 or of the second set S2, each of first distances S1D1, S1D2 between the first axis A1 and the connectors of the first set S1 of connectors equals an associated one of second distances S2D1, S2D2 between the second axis A2 and the connectors of the second set S2 of connectors. In the depicted embodiment, each of the contact surfaces 24A of the connectors 24 of the first set S1 is oriented in a respective one of first directions D11, D12 and each of the contact surfaces 24A of the connectors 24A of the second set S2 is oriented in a respective one of second directions D21, D22. The first directions D11, D12 and the second directions D21, D22 are radial relative to the first axis A1 and the second axis A2, respectively. Herein, their directions are solely radial. It will be appreciated that, alternatively, each of the first directions D11, D12 may be different from one another and equal to an associated one of the second directions D21, D22.

Referring to FIG. 7, an example of a scaled-down cap interface is shown at 12′. As the motorization unit 14 received in the pair of adjacent cap interfaces 12′ is smaller, the annular base 21 has a smaller diameter as a function of the smaller motorization unit 14. However, it may be desired that the struts 13 interconnecting a pair of cap interfaces 12 in a link 10A be parallel. Therefore, the cap end 22 may be larger than the annular base 21 in the cap interfaces 12′ in contrast to the cap interfaces 12. Also, some of the connector slot 24 may have a spacer base 25. In such an arrangement, the spacing between all connector slots 24 of a set S1 in the robot arm 10 may be the same, in spite of the presence of scaled down cap interfaces 12′. Likewise, in an embodiment, the spacing between all connector slots 24 of a set S2 in the robot arm 10 may be the same, in spite of the presence of scaled down cap interfaces 12′. Stated differently, the circumferential distribution of connector slots 24 of sets S1 and S2 is preserved through the cap interfaces 12 and 12′, i.e., the diameter encompassing the connectors in the cap interfaces 12 and 12′.

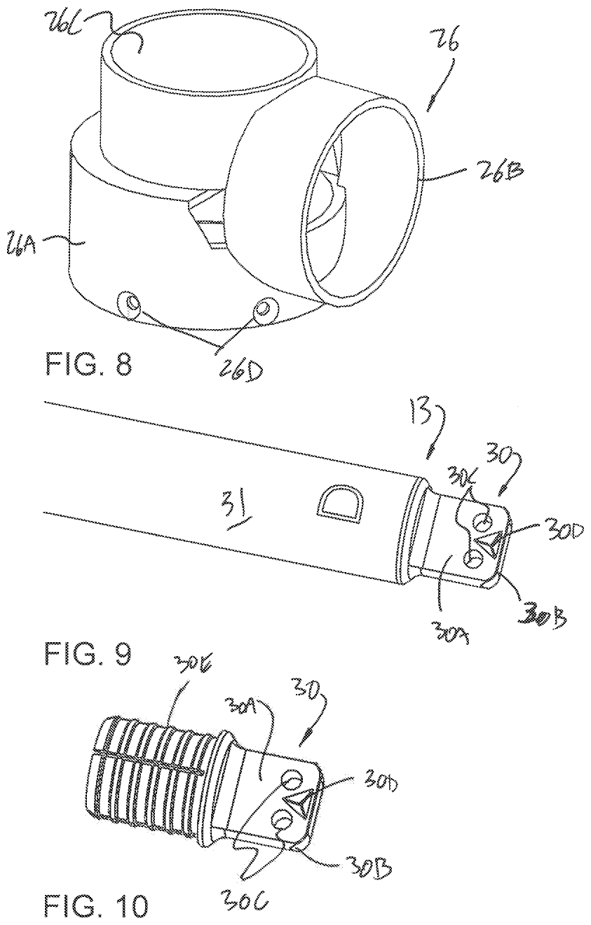

In FIG. 8, a skin 26 in accordance with one embodiment is shown generally at 26. The skin 26 is sized for covering a cap interface 12. In an embodiment, the skin 26 could be used instead of the receptacle body 20, but with appropriate connector means for connection of the struts 13 thereto. For the skin 26 to be universal (i.e., usable for transverse arrangement and parallel arrangement and/or any other angled arrangement), it may have an annular base 26A, and an open longitudinal tubular portion 26B (transverse arrangement) and an open transversal tubular portion 26C (parallel arrangement). Skins 26 could also be nipple type only (parallel arrangement) or elbow type (transverse arrangement). The annular base 26A may have its set of circumferentially distributed holes 26D, aligned with the holes 21A of the annular base 21. Single fasteners could pass through the aligned holes of the skin 26, the cap interface 12 and motorization unit 14 to fix these components to one another. In an embodiment, the skin 26 is optional and absent from the robot arm 10. In another embodiment, a skin 26 is present in only some of the joints between adjacent cap interfaces 12. In another embodiment, the skin 26 is not attached by fasteners to the cap interface 12.

Referring to FIGS. 9 and 10, an exemplary strut 13 is shown. For simplicity, the exemplary components of the struts 13 will be given reference numerals in the 30s in the description. Opposed ends of the struts 13 have connectors that are complementary to the connectors of the cap interfaces 12/12′. In the illustrated embodiment, the connectors of the struts 13 are connector tabs 30, though slots, holes, etc. could be present as well. The connector tabs 30 are interfaced with the connector slots 24. The connector tabs 30 have a contact surface 30A that may be contoured by periphery 30B, In an embodiment, the contact surface 30A is generally flat, but may be arcuate, slotted, etc—it is complementary in shape to the contact surface 24A of the connector slot 24 for complementary surface contact (e.g., coplanar). Hole(s) 30C may be defined in the contact surface 30A, and a pair is shown in FIGS. 9 and 10 to replicate the hole distribution in the connector slot 24. The holes 30C may be threaded or not and sized to receive fasteners therein. One or more alignment features 30D, again in complementary feature to that or those of the cons 24, may be present. In an embodiment, the alignment features 30D may be carved in the contact surface 30A (though the contrary is also contemplated). In an embodiment, the alignment feature 30D tapers inwardly. The alignment feature 30D may be for example a triangular-base pyramid groove being a negative of the alignment feature 24D of the connector slot 24. The alignment feature 30D may assist in precisely connecting the struts 13 to the cap interfaces 12. A plug end 30E may define one end of the connector tab 30. The plug end 30E may have surface features such as wedges and/or a central slot to use a biasing effect when the plug end 30E is fitted in a tube 31. The plug end 30E may consequently be held captive in the tube 31, for instance by friction only, or by using an adhesive or other joining method.

The tube 31 is open ended so as to receive connector tabs 30 at its opposed ends. The tube 30 spaces apart the connector tabs 30 by select distances. The tubes 31 may be made of any appropriate material. In an embodiment, the tubes 31 may be plastic or metal extrusions. In another embodiment, the tubes 31 are made of composite materials, such as carbon fiber or fiberglass tubes, with a high stiffness to weight ratio. Other materials are contemplated as well. It is also contemplated to allow the tubes 31 to be cut to an appropriate length, though the tubes 31 could be available in a subset of lengths.

The number of struts 13 in each link 10A may be the same or may differ in a same robot arm 10. According to an embodiment, there may be a greater number of struts 13 proximally as the base end 11B may have to bear a greater load, notably that of the robot arm 10. In an embodiment, there are at least two struts 13 between each set of cap interfaces 12. The presence of pairs of holes 24C and 30C, of the alignment features 24D and 30D, and/or abutment between walls 24B and periphery 30B may contribute to a bracing effect between the cap interfaces 12 of a same link 10A.

Referring to FIGS. 11 and 12, an exemplary one of the motorization units 14 is shown. The motorization unit 14 may have a first shell 40A and a second shell 40B. In an embodiment, a plane between the shells 40A and 40B has a vector of the rotational axis of the motorization unit 14 normal to it. The shells 40A and 40B may have surface features complementary to those of the cap interfaces 12. For example, holes 41 are circumferentially distributed to match a pattern of the holes 21C in the cap interfaces 12. An exemplary interior of the motorization unit 14 shows bearings, a circular spline 42A, a shaft 42B, coils and magnets 42C, among other components, to cause a relative rotation between the shells 40A and 40B. These are shown schematically as an example. One possible motorization unit 14 that may be used in the robot arm 10 of the present disclosure is shown in U.S. patent application Ser. No. 16/570,391, incorporated herein by reference. One or more of the motorization units 14 may have a controller board, for instance as embodied by a printed-circuit board (PCB). Wires 43 (e.g., a wire band) may extend from a motorization unit 14 to an adjacent motorization unit 14, and may have plugs for connection to motorization units 14 in series, to facilitate an assembly of the robot arm 10.

Referring to FIG. 13, another embodiment is shown, in which cap interfaces 12″ are connected to tubes 31 by male/female connection. Hence, the tubes 31 may be without connectors at their ends. The cap interfaces 12″ have mount brackets 50 in the first set S1, for receiving tubes 31 therein. Holes 51 are used in the second set S2. FIG. 13 illustrates another possibility in terms of connector configuration between cap interfaces 12 and struts 13.

A base mount 60 in such an embodiment is defined by a plate 61 with connectors, in the form of female tubes 62, for receiving the tubes 31 therein. Alternatively, the connectors may be plugs that may be received in the free ends of the tubes 31. There may be more connectors 62 than on the cap interfaces 12″, to allow versatility in the connection of struts to the base mount 60. The base mount 60 may be wall mounted for example, or may be mounted to any appropriate structure as detailed above. Holes 63 may be present for the anchoring of the plate 61 to a flat surface, as one possibility to secure the base mount 60 to a structure.

The base mount 60 may be used as an alternative to the docking cradle or base shown in FIGS. 1 and 2, at the base end 11B. The contrary arrangement may be used with both the cap interfaces 12″ and the base mount 60, i.e., the tubes 31 of the struts 13 may be female connectors.

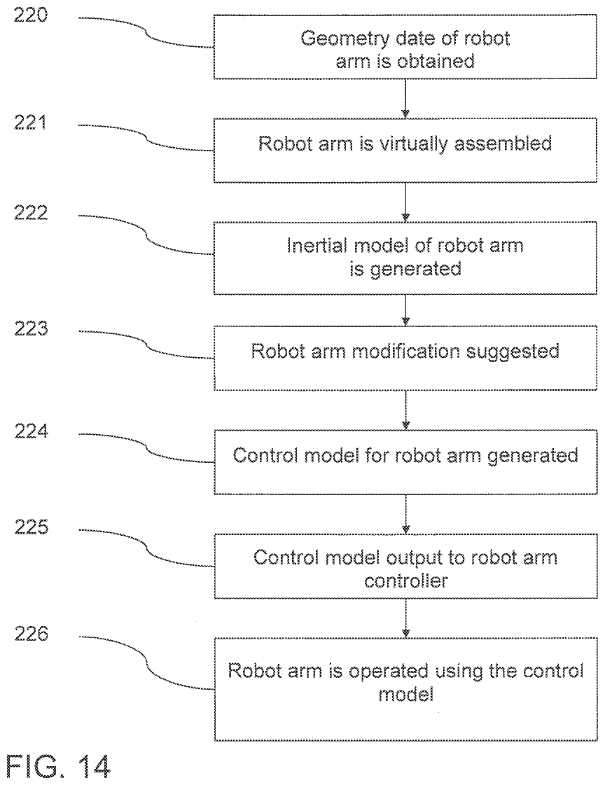

Referring to FIG. 14, an exemplary method for creating a control model specific to the robot arm 10 is presented. The method may be of the type performed by a processing unit, and may be in the form of a non-transitory computer-readable memory communicatively coupled to the processing unit. In an embodiment, the methods are performed in a first processing unit (e.g., cloud-based computing), and the instructions are programmed into a controller of the robot arm 10, such as computer-readable program instructions executable by the processing unit. As the robot arm 10 is modular, the control model will be dependent on the resulting robot arm geometry and arrangement.

In 220, the geometry data of the robot arm is obtained, namely, the number of joints, the size of the motorization units 14 at the joints, the distance between links (e.g., the distance between rotational planes at the ends of any link), the orientation of the rotational axes. The geometry data may be based on the hardware that is used, for instance by having the user enter information about the selection of components via a user interface. Hence, the geometry data may define the overall configuration of the robot arm (e.g., the number of DOFs, serial or SCARA type, etc.), the number of motorized joints 14, the size of each motorized joint 14, the length of the links 10A, 10B between pairs of the motorized joints 14, the transverse, parallel or other angled arrangement (i.e., relative orientation between joints), the type of end effector at effector end 11A, the type of base at base end 11B. In one embodiment, the user enters the robot arm configuration using for example a word processor software. In another embodiment, the geometry data is entered using a graphical user interface (GUI), for example with drop-down menus, text boxes, widgets, etc. In another embodiment, the geometry data specific to the created robot arm 10 may be generated by having the user clicking and dragging icons on a graphical interface.

Once the geometry data is obtained, the processing unit may virtually assemble the various components to build the desired robot arm, in 221. In this step, a subassembly may first be generated and then attached to a previous subassembly. The processor unit may display the virtual model of the robot arm 10. This may allow the user to verify the model against a constructed version of the robot arm 10, if already built. Alternatively, it may allow the user to play with a virtual model of the robot arm 10 before constructing it. When assembling the robot arm 10 in 221, the processing unit may determine the overall dimensions, the workspace, the degrees of freedom and the link interferences can be checked. This may be achieved by performing a movement simulation of the robot arm 10 assembled in 221, and may include the possibility of having a user operating the movement simulation with a user interface, such as a joystick, keyboard, touchscreen, etc.

In 222, the processing unit obtains inertia data, mass properties, rigidity of the links 10A, 10B between the parts of motorized joint units 14 etc for the components of the virtual robot arm 10. For instance, the inertia data, mass properties, rigidity of the links 10A, 10B is obtained from a database containing component specifications, e.g., manufacturing specs. The processing unit may generate an inertial model and/or a rigidity model of the robot arm 10. The inertial model impacts the operation of the robot arm 10, notably the torque required at the joints.

In 223, the processing unit may suggest modifications to the robot arm 10, notably by the addition or subtraction of struts 13, the use of larger or smaller motorization units 14, the substitution of components to achieve a similar workspace for lessened complexity, etc.

In 224, with a finalized robot arm 10, the processing unit 10 generates a control model specific to the finalized robot arm 10. The control model may be computer-readable program instructions executable by a processing unit on the robot arm 10, to control the robot arm 10 as a function of its specific geometry. The control model may including a calibration configuration for the calibration of the robot arm at operation. In 225, the control model may be output and programmed into processing unit of the controller of the robot arm 10, if 220-224 were not performed directly into the robot arm 10. In 226, with the control model in the controller of the robot arm 10, the controller may operate the robot arm 10 as a response to teleoperation instructions from a user, or to further programming from the user, in a real or virtual environment.

For creating and assembling an articulated robot arm a number of motorized joints of various sizes is determined; a number of link members of various lengths is obtained and releasably attached to the base end; a first number of link members of a first length is releasably attached on one end to said first motorized joint; a second motorized joint of any size is determined and releasably attached on the other end to the said first number of said link members of said first length; a Nth motorized joint of any size is determined and releasably attached on the other end to the said N−1th number of link members of said N−1th length; a wrist member is releasably attached to the Nth motorized joint; wherein each of the N motorized joints can be of any size; each of the N−1 link members between each pair of the N motorized joints can be of various lengths as long as the length is the same between a specific pair of motorized joints; each of the N−1 number of link members between each pair of the N motorized joints can be of various quantities.

For automatically generating the tool, control and calibration configuration files of a robot arm a robot arm description file is created; a CAD model of the robot arm is generating automatically based on the robot arm description file; the URDF file is automatically created based on the CAD model; the tool, control and calibration configuration files automatically generating based on the URDF file.

The robot arm description file may be created by using a word processor software. The method of claim 39 wherein the robot arm description file is created by using a drop-down menu interface. The robot arm description file may be created by clicking and dragging icons from a graphical interface. The robot arm description file may be created by using voice commands through an interface.

Embodiments disclosed herein includes:

A. A motorized joint assembly for a modular robot arm comprising: a motorized unit having a first shell and a second shell rotatable relative to the first shell about a rotation axis, a motor disposed within and secured to one of the first shell and the second shell, the motor in driving engagement with the other of the first shell and the second shell; a first cap interface mounted on the first shell and a second cap interface mounted on the second shell, the first cap interface defining a first set of connectors for connecting structural members of the modular robot in a first orientation and a second set of connectors for connecting the structural members in a second orientation different than the first orientation.

B. A modular robot arm comprising: a base securable to a support, the base having a base motorized joint; an effector interface end; and at least one link connecting the effector interface end to the base, the at least one link including a proximal cap interface at a proximal end and connected to the base motorized joint, a distal cap interface at an opposite distal end and connected to a second motorized joint, and struts connecting the proximal cap interface to the distal cap interface, at least one of the proximal cap interface and the distal cap interface defining a first set of connectors and a second set of connectors, the struts selectively connected to the at least one of the proximal cap interface and the distal cap interface along a selective one of a first orientation via the first set of connectors and a second orientation different than the first orientation via the second set of connectors.

Embodiments A and B may include any of the following elements, in any combinations:

Element 1: the base hosting the first motorized joint contains the modular robot arm controller. Element 2: the base hosting the first motorized joint has a quick connect mechanism to attach it to a docking cradle. Element 3: the docking cradle contains the modular robot arm controller. Element 4: the controller is external of the robot arm. Element 5: the mounting interface fixed at the end of the at least one link member has a corresponding protrusion. Element 6: the protrusion and the corresponding notch are shaped like a pyramid, a cube, a prism, etc. Element 7: the at least one link member and its mounting interface are constructed in one solid piece. Element 8: the two or more mounting notches are spaced evenly on the cap. Element 9: the two or more mounting notches are not spaced evenly on the cap. Element 10: the at least one ring is round shaped. Element 11: the at least one ring is shaped like a square, a rectangle, a triangle, an ellipse, etc. Element 12: the base is mounted on a mobile platform. Element 13: the tubes or bars are made of polymeric material, metallic material, composite material, etc. Element 14: the struts have a circular, rectangular. Element 15: the connectors of the first set of connectors are distributed circumferentially around a first axis and the connectors of the second set of connectors are distributed about a second axis non-parallel to the first axis. Element 16: the first axis is parallel to the rotation axis and wherein the second axis is perpendicular to the first axis. Element 17: a number of the first set of connectors corresponds to a number of the connectors of the second set of connectors, each of first distances between the first axis and the connectors of the first set of connectors equals an associated one of second distances between the second axis and the connectors of the second set of connectors. Element 18: the first distances extend from the first axis to first contact surfaces of the first connectors and wherein the second distances extend from the second axis to second contact surfaces of the second connectors. Element 19: each of the first contact surfaces is oriented in a respective one of first directions and each of the second contact surfaces is oriented in a respective one of second directions, the first directions and the second directions being radial relative to the first axis and the second axis. Element 20: the first contact surfaces and the second contact surfaces define alignment features. Element 21: the first orientation is normal to the second orientation. Element 22: the connectors of the first set of connectors are slots defined in an outer face of the first cap interface, the connectors of the second set of connectors being slots defined in an outer face of the second cap interface. Element 23: the connectors are female tubular members. Element 24: the struts are releasably attached to the at least one of the proximal cap interface and the distal cap interface. Element 25: both the proximal cap interface and the distal cap interface defines the first set of connectors and the second set of connectors. Element 26: the first orientation is parallel to an axis of rotation of a corresponding one of the base motorized joint and the second motorized joint and the second orientation is perpendicular to the axis of rotation. Element 27: the connectors of the first set of connectors are distributed circumferentially around a first axis and the connectors of the second set of connectors are distributed about a second axis non-parallel to the first axis. Element 28: a number the connectors of the first set of connectors corresponds to a number of the connectors of the second set of connectors, each of first distances between the first axis and the connectors of the first set of connectors equals an associated one of second distances between the second axis and the connectors of the second set of connectors. Element 29: the first distances extend from the first axis to first contact surfaces of the first connectors and wherein the second distances extend from the second axis to second contact surfaces of the second connectors. Element 30: each of the first contact surfaces is oriented in a respective one of first directions and each of the second contact surfaces is oriented in a respective one of second directions, the first directions and the second directions being radial relative to the first axis and the second axis. Element 31: the connectors of the first set of connectors are slots defined in an outer face of the first cap interface, the connectors of the second set of connectors being slots defined in an outer face of the second cap interface. Element 32: the connectors are female tubular members.

As can be seen therefore, the examples described above and illustrated are intended to be exemplary only. The scope is indicated by the appended claims.

What is claimed is:

1. A motorized joint assembly for a modular robot arm comprising: a motorized unit having a first shell and a second shell rotatable relative to the first shell about a rotation axis, a motor disposed within and secured to one of the first shell and the second shell, the motor in driving engagement with the other of the first shell and the second shell; a first cap interface mounted on the first shell and a second cap interface mounted on the second shell, the first cap interface defining a first set of connectors for connecting structural members of the modular robot in a first orientation and a second set of connectors for connecting the structural members in a second orientation different than the first orientation.

2. The motorized joint assembly of claim 1, wherein the connectors of the first set of connectors are distributed circumferentially around a first axis and the connectors of the second set of connectors are distributed about a second axis non-parallel to the first axis.

3. The motorized joint assembly of claim 2, wherein the first axis is parallel to the rotation axis and wherein the second axis is perpendicular to the first axis.

4. The motorized joint assembly of claim 2, wherein a number of the first set of connectors corresponds to a number of the connectors of the second set of connectors, each of first distances between the first axis and the connectors of the first set of connectors equals an associated one of second distances between the second axis and the connectors of the second set of connectors.

5. The motorized joint assembly of claim 4, wherein the first distances extend from the first axis to first contact surfaces of the first connectors and wherein the second distances extend from the second axis to second contact surfaces of the second connectors.

6. The motorized joint assembly of claim 5, wherein each of the first contact surfaces is oriented in a respective one of first directions and each of the second contact surfaces is oriented in a respective one of second directions, the first directions and the second directions being radial relative to the first axis and the second axis.

7. The motorized joint assembly of claim 5, wherein the first contact surfaces and the second contact surfaces define alignment features.

8. The motorized joint assembly of claim 1, wherein the first orientation is normal to the second orientation.

9. The motorized joint assembly of claim 1, wherein the connectors of the first set of connectors are slots defined in an outer face of the first cap interface, the connectors of the second set of connectors being slots defined in an outer face of the second cap interface.

10. The motorized joint assembly of claim 1, wherein the connectors are female tubular members.

11. A modular robot arm comprising: a base securable to a support, the base having a base motorized joint; an effector interface end; and at least one link connecting the effector interface end to the base, the at least one link including a proximal cap interface at a proximal end and connected to the base motorized joint, a distal cap interface at an opposite distal end and connected to a second motorized joint, and struts connecting the proximal cap interface to the distal cap interface, at least one of the proximal cap interface and the distal cap interface defining a first set of connectors and a second set of connectors, the struts selectively connected to the at least one of the proximal cap interface and the distal cap interface along a selective one of a first orientation via the first set of connectors and a second orientation different than the first orientation via the second set of connectors.

12. The modular robot arm of claim 11, wherein the struts are releasably attached to the at least one of the proximal cap interface and the distal cap interface.

13. The modular robot arm of claim 11, wherein both the proximal cap interface and the distal cap interface defines the first set of connectors and the second set of connectors.

14. The modular robot arm of claim 11, wherein the first orientation is parallel to an axis of rotation of a corresponding one of the base motorized joint and the second motorized joint and the second orientation is perpendicular to the axis of rotation.

15. The modular robot arm of claim 11, wherein the connectors of the first set of connectors are distributed circumferentially around a first axis and the connectors of the second set of connectors are distributed about a second axis non-parallel to the first axis.

16. The modular robot arm of claim 15, wherein a number the connectors of the first set of connectors corresponds to a number of the connectors of the second set of connectors, each of first distances between the first axis and the connectors of the first set of connectors equals an associated one of second distances between the second axis and the connectors of the second set of connectors.

17. The modular robot arm of claim 16, wherein the first distances extend from the first axis to first contact surfaces of the first connectors and wherein the second distances extend from the second axis to second contact surfaces of the second connectors.

18. The modular robot arm of claim 17, wherein each of the first contact surfaces is oriented in a respective one of first directions and each of the second contact surfaces is oriented in a respective one of second directions, the first directions and the second directions being radial relative to the first axis and the second axis.

19. The modular robot arm of claim 11, wherein the connectors of the first set of connectors are slots defined in an outer face of the first cap interface, the connectors of the second set of connectors being slots defined in an outer face of the second cap interface.

20. The modular robot arm of claim 11, wherein the connectors are female tubular members.
